(19) United States
(12) Patent Application Publication
(10) Pub. No.: US 2020/0059194 A1
(43) Pub. Date: Feb. 20, 2020

(54) ADJUSTABLE SOLAR PANEL FOR A TOWER

(71) Applicant: Wilbur L. Anderson, Inc. d/b/a Western Towers, San Angelo, TX (US)

(72) Inventors: Charles Anderson, San Angelo, TX (US); Sean Gallagher, San Angelo, TX (US)

(21) Appl. No.: 16/359,620

(22) Filed: Mar. 20, 2019

Related U.S. Application Data
(60) Provisional application No. 62/674,716, filed on May 22, 2018.

(51) Int. Cl. H02S 20/32

(52) U.S. Cl. CPC H02S 20/32

(57) ABSTRACT

A tower having a solar panel attached at the top of the tower. The solar panel is attached with a bracket having a movable arm and fixed arm. Both arms pivotally engage a rear of the panel. The pivot arm is attached to a long shaft that extends all the way to the ground and is movable from the ground to adjust the angle of the solar panel.

This application claims the benefit of, incorporates by reference, and priority to Application No. 62/674,716, filed May 22, 2018.

### FIELD OF THE INVENTION

Towers including, in some embodiments, tilt tube towers having a mast and tilt tube with a solar panel or other device mounted to the mast by means remotely adjusting an angle of the solar panel.

### BACKGROUND OF THE INVENTION

Tilt tube towers are used for, among other things, railroad tower wireless correspondence. (See U.S. Pat. Nos. 8,863,450 and 8,800,219, incorporated by reference for background structure generally of tilt tower assemblies.)

### SUMMARY OF THE INVENTION

A solar panel is provided to generate electricity to charge a battery or batteries, which in turn can operate equipment used in the communications operation of a cell phone, PTC or any tower or any other use. The solar panel is provided with a bracket assembly to hold it at a predetermined, adjustable angle with respect to the tilt tube tower and, moreover, with a bracket assembly that allows remote adjustment of the angle of the solar panel. The remote adjustment allows the solar panel to be mounted well out of reach of a person standing on the ground, but the adjustment assembly is provided at ground level so an adjustment can be made remotely or when the solar panel is out of reach of a person standing on the ground.

A tilt tube tower for attachment to a foundation in the ground, the tilt tube tower having a mast having a removed end and a near end, the near end close to the foundation, a tilt tube is rotatably mounted to the removed end of the mast on one side of the multi-sided mast. An antenna is attached to the tilt tube at one end thereof. A solar panel, a bracket assembly engage the mast and solar panel, the bracket assembly mounted to the mast below the removed end so as to pivotally hold the solar panel spaced away from the mast and tilt tube, on a side not the one side of the mast, and at a selected angle with respect to the mast. An adjustment assembly is located at or near the end of the mast; and a slideable shaft is provided, slideable with respect to the mast, for engaging the adjustment assembly and the bracket assembly so that movement of the shaft at the adjustment assembly causes the solar panel to change its tilt angle. The adjustment assembly may fixedly locate the slideable shaft when a desired solar panel tilt orientation is achieved.

A tilt tube tower is provided for attachment to a foundation in the ground, the tilt tube tower having a mast having a removed end and a near end, the near end close to the foundation. A tilt tube is provided rotatably mounted to the removed end of the mast. An antenna is attached to the tilt tube at one end thereof. A solar panel and a bracket assembly engaging the mast and solar panel is provided. The bracket assembly is mounted to the mast below the removed end so as to pivotally hold the solar panel spaced away from the mast and tilt tube and at a selected angle with respect to the mast. An adjustment assembly is located at or near the end of the mast. A slideable shaft, slideable with respect to the mast, is provided for engaging the adjustment assembly and the bracket assembly so that movement of the shaft at the adjustment assembly causes the solar panel to change its tilt angle, the adjustment assembly for fixedly locating the slideable shaft when a desired solar panel tilt orientation is achieved.

### BRIEF DESCRIPTION OF THE DRAWINGS

FIGS. 1 and 1A illustrate a tilt tower having a solar panel attached to a mast with an adjustable bracket, which allows adjustment of a tilt angle of the solar panel with respect to the tilt tower and which adjustment may be made remotely, as by a person standing on the ground and out of reach of the solar panel.

FIG. 2 is an illustration of FIG. 1, but rotated 90°, so the viewer is seeing the solar panel in front view, in this embodiment with the solar panel mounted on a side of the mast adjacent to the tilt tube.

FIG. 3 is a detail view of the adjustable bracket and the solar panel on the tube for remotely operating the adjustable bracket.

FIGS. 3A and 3B illustrate details of the engagement of the sleeve assemblies.

FIG. 4 is an illustration of the bottom located adjustment assembly and shaft for adjusting the angle of the solar panel through the adjustable bracket.

FIG. 5 is another detail view of the button located adjustment assembly.

### DETAILED DESCRIPTION OF THE PREFERRED EMBODIMENT

The Figures illustrate a tilt tower assembly 10, which may have a mast or base tube 12, which in turn is fastened to a foundation embedded in the earth. Tilt tower assembly 10 may, in some embodiments, include a base or mast tube 12 with a tilt tube 14 pivotally mounted to a removed end thereof. On one end of the tilt tube may have an antenna for transmitting and/or receiving wireless signals and the tilt tube may have a lanyard 15 for limiting pivotal movement of the tilt tube (for servicing the antenna while standing on the ground) in ways known in the art. A pivot bolt or pivot member 18 located at the removed end of the mast allows tilt tube 14 to pivot with respect thereto. By lowering the antenna end of the tilt tube to an angle at about 90° with respect to the base tube 12 allows one to service the antenna by standing on the ground, rather than having to go up to the antenna as by a ladder, crane or the like.

Tilt tube towers, as well as non-tilt tube towers, may require electrical energy and, in some embodiments disclosed herein, that energy may be provided by a solar panel assembly 20, which charges a remote battery which in turn provides electrical power for the equipment stored in an equipment cabinet 62, which may be a NEMA enclosure enclosing the battery for operative engagement with the solar panel, in some embodiments, having multiple solar cells thereon for converting radiant energy to electrical energy.

Solar panel assembly may include solar panel 21 having top edge 21a. The solar panel assembly is mounted typically well above arm's reach on the mast or base tube 12. Therefore, adjustment may be difficult, so remote adjustment is provided for as more specifically set forth herein. Solar panel 21 of solar panel assembly 20 is mounted spaced away from the mast that it is mounted on, spaced away from the upper region or area of base tube 12. The manner of spacing solar panel 21 is the use of a standoff, multi pivot bracket assembly 22. The manner in which bracket assembly 22 provides for pivoting solar panel 21 is by mounting a double pivot arm 32 at an upper end 44 of removable adjustable shaft 40 which may be adjusted from ground level as set forth in more detail below.

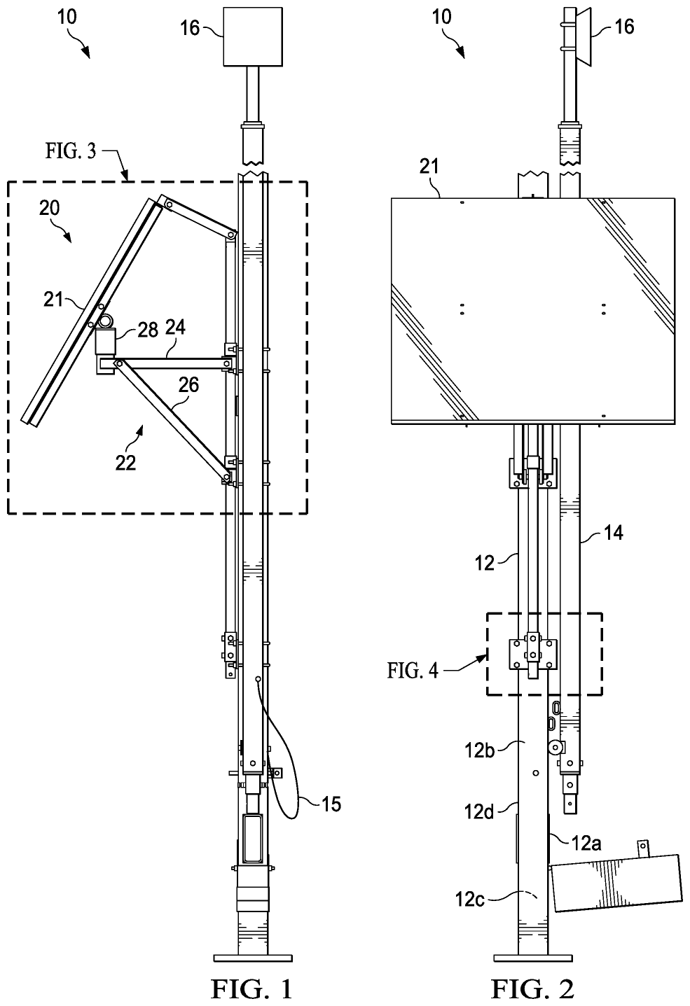

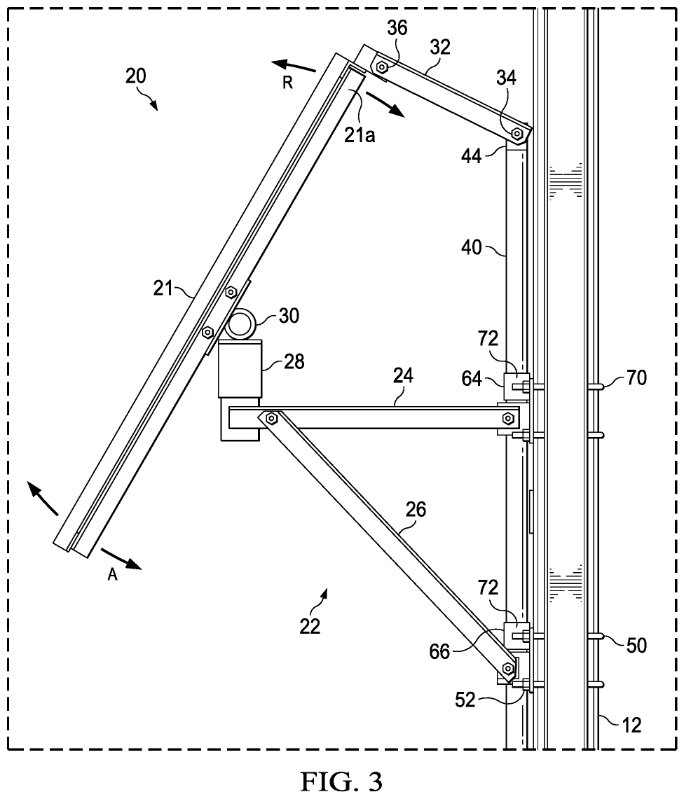

Turning back to multi pivot standoff bracket assembly 22, it is seen to have at least a first arm 24 for locating the solar panel spaced away from the base tube. A second arm 26 may be used in a diagonal manner as set forth in FIG. 3 to help first arm 24 support solar panel 21. An upright arm 28, in some embodiments, may be provided at the removed end of first arm 24, upright arm 28 having a fixed pivot end 30 (fixed with respect to the base tube) for pivotally locating solar panel 21 at a fixed point between an upper and lower edge of solar panel 21, typically somewhere near the center (see FIG. 3). In some embodiments, upright arm 28 may be omitted and the ends of arms 24/26 (one or both) may be attached to the rear of the solar panel at a pivot point. Fixed pivot end 30 is designated “fixed” because the pivot point itself is fixed with respect to the tilt tower but allows rotation of solar panel 21 in the direction indicated by the arrows A as seen in FIGS. 1 and 3. The torque actually causing or driving the rotation about pivot end 30 is double pivot arm 32, which has a first movable pivot point 34 attached to a vertically movable adjustable shaft 40 as seen in FIG. 3, and second movable pivot point 36 pivotally attached at or near top edge 21a of solar panel 21. Embodiments may pivot on the lower edge or other suitable locations. Embodiments may delete the tilt tube and mount other types of electrical devices to the removed end of base tube 12. In other embodiments, pivot arm and adjustment may be made from the bottom edge, with location sleeves spaced well away from the movable pivot on the adjustment shaft.

Turning back to first and second arms 24/26, it is seen that the ends closest to the base tube are mounted on first and second locator sleeve assemblies 64/66 (see FIGS. 3A and 3B), which are designed to both slidably locate movable adjustable shaft 40 so it may slide vertically up and down with respect to the mast, but also may act as inboard supports for arms 24/26, which are attached to mast 12 (that is, they do not move up and down like first movable pivot point 34). The first and second locator sleeve assemblies may have mounting plates 68, mounted to the mast by fasteners, such as U-bolts 70 or by other suitable means. On the mounting plate is a cylindrical locating sleeve 72, which has an internal diameter just slightly larger than the external diameter of adjustable shaft 40. Sleeves 72 may be welded or otherwise fastened to plate 68. Plate 68 may also have mounted thereto arm mounting bosses 74 for receipt of fasteners therethrough, which fasteners will entrain the near ends of arms 24/26, so as to support or provide support for solar panel 21 (see FIG. 3). Multiple sleeves may be provided at multiple locations along the mast.

As seen in FIG. 1A, one of the preferred embodiments, has a pair 24/24a and 26/26a of laterally adjacent arms which mount on bosses 74 of mounting plate 68 of second locator sleeve assembly 66, which paired arms have additional rigidity to the solar panel to prevent twist, for example, in winds.

Turning back to double pivot arm 32, it may be seen that when first movable pivot point 34 moves upward from the position indicated in FIG. 3, pivot point 34 will move counterclockwise, while if first movable pivot point 34 moves downward with respect to the position indicated in FIG. 3, the top edge 21a will move clockwise to a less steep angle with respect to the horizontal.

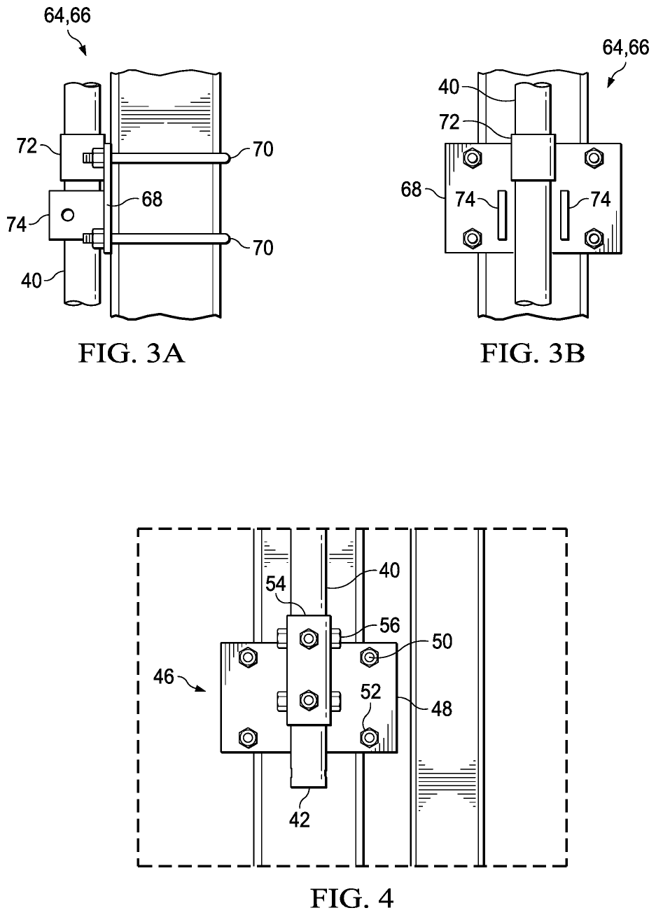

Turning now to the lower end of mast 12, it may be seen with respect to FIGS. 1, 1A, 2, 4, and 5, that there is an adjustor assembly 46 located, typically within about one to six feet of the ground, functioning to adjust the tilt angle of the solar panel in the manner indicated by arrows R in FIG. 3 to best locate the angle of the solar panel with respect to the rays of the sun to optimize its efficiency.

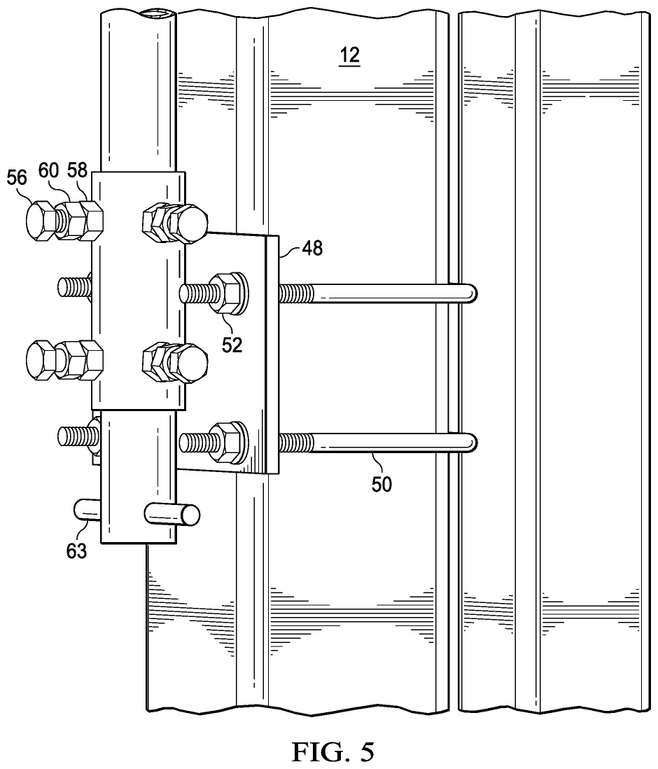

Adjuster assembly 46 is seen to have a mounting plate 48 held to a low end of the mast by means of fasteners 50 and nuts 52, which fasteners may be U-bolts as seen in FIG. 5. A lock or set sleeve 54 with an internal diameter slightly greater than the external diameter of adjustment shaft 40 encloses the adjustment shaft near the removed end thereof. On the set sleeve is mounted threaded bosses or lugs 58 for receipt of set screws 56 therein, which set screws may include lock nuts 60 (see FIG. 5). Lock nuts 60 prevent inadvertent backing out of the set screws when set. There is typically more than one, here six, set screws and the removed end will pinch against the external diameter of adjustable shaft 40 when the proper angle of tilt is achieved, which angle of tilt is achieved by moving lower end 42 up or down and thereby pivoting top edge 21a of solar panel 21 to achieve a desired angle. Handle 63 may be provided to help raise or lower movable adjustment shaft 40 when the set screws are backed out.

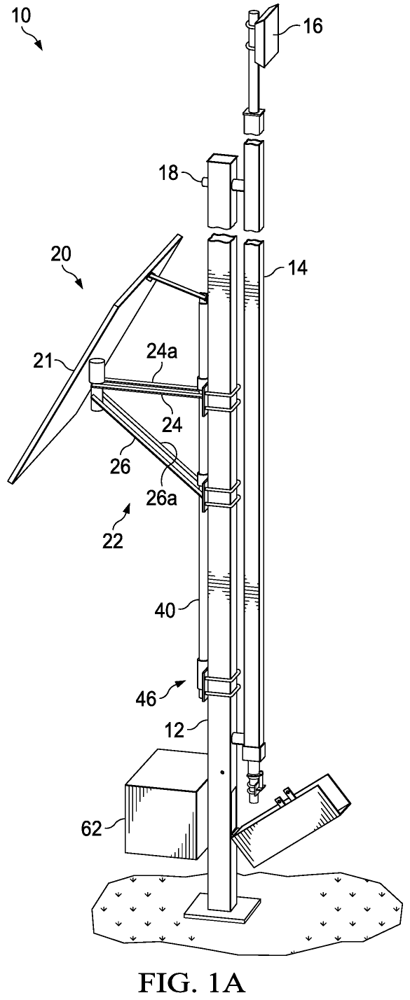

It is noted that mast or base tube may have sides 12a/12b/12c/12d as seen in FIG. 2. Assuming side 12a is the side of the tilt tube is in front of the tube, side 12d may be considered the side opposite the tilt tube is mounted (see FIG. 2), where sides 12c/12b are sides adjacent to the side the tilt tube is mounted. As seen in FIG. 2, solar panel 21 and adjuster shaft 40 are mounted on an adjacent side, here 12b. It is noted that the tilt panel, in some embodiments, should be at least 60° from horizontal prior to tilting the tower when mounted on an adjacent side, moreover, the tower should be mounted high enough and the angle steep enough so that the tilt tube can be lowered (with a lanyard to act as a stop) without striking solar panel 21. The solar panel, in some embodiments, may be mounted between 8 and 15 feet below the tilt tube pivot point. In some embodiments, the solar panel is mounted about 11 feet off the ground or in the range of 8 to 20 feet off the ground or any suitable location where it is exposed to the sun and free of blocking structures, natural or manmade. A ladder may be used when servicing the antenna (tilt tube in lowered or pivoted position). In some embodiments, the solar panel is about 2′×2′ 6″.

Note that while a tilt tube is shown, it is not necessary and the solar panel assembly and remote adjuster may be used on any mast, tower, building or other suitable structure.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A tower for attachment to a foundation in the ground, the tower having:
a mast having a removed end and a near end, the near end close to the foundation;
a solar panel;
a standoff bracket assembly engaging the mast and the solar panel, the bracket assembly having fixed arms engaging the mast and the solar panel, and a pivot arm engaging the solar panel, the bracket assembly mounted to the mast close to the removed end so as to pivotally hold the solar panel spaced away from the mast and at a selected tilt angle with respect to the mast; and
an adjustment assembly located at or close to the near end of the mast and at the or close to the removed end, the adjustment assembly including a slideable shaft slideable with respect to the mast, for pivotally engaging the pivot arm of the bracket assembly so that movement of the slideable shaft with respect to the mast causes the pivot arm to cause the solar panel to change its tilt angle, the adjustment assembly for fixedly locating the slideable shaft when a desired solar panel tilt orientation is achieved.

2. The tower of claim 1, wherein the pivot arm engages the solar panel along a top edge thereof.

3. The tower of claim 2, wherein the fixed arms engage the solar panel about midway between the top edge and a bottom edge thereof to allow the panel to pivot at an engagement point.

4. The tower of claim 1, wherein the fixed arms include a horizontal arm and a diagonal arm.

5. The tower of claim 4, wherein the horizontal arm comprises a pair of arms and wherein the diagonal arm includes a pair of arms.

6. A tower for attachment to a foundation in the ground, the tower having:
a mast having a removed end and a near end, the near end close to the foundation;
a solar panel;
a standoff bracket assembly engaging the mast and the solar panel, the bracket assembly having fixed arms engaging the mast and the solar panel, and a pivot arm engaging the solar panel, the bracket assembly mounted to the mast close to the removed end so as to pivotally hold the solar panel spaced away from the mast and at a selected tilt angle with respect to the mast; and
an adjustment assembly located at or close to the near end of the mast and at the or close to the removed end, the adjustment assembly including a slideable shaft slideable with respect to the mast, for pivotally engaging the pivot arm of the bracket assembly so that movement of the slideable shaft with respect to the mast causes the pivot arm to cause the solar panel to change its tilt angle, the adjustment assembly for fixedly locating the slideable shaft when a desired solar panel tilt orientation is achieved;
wherein the pivot arm engages the solar panel along a top edge thereof;
wherein the fixed arms engage the solar panel about midway between the top edge and a bottom edge thereof;
wherein the fixed arms include a horizontal arm and a diagonal arm; and
wherein the horizontal arm comprises a pair of arms and wherein the diagonal arm includes a pair of arms.

7. A tilt tower for attachment to a foundation in the ground, the tilt tower having:
a mast having a removed end and a near end, the near end close to the foundation;
a tilt tube rotatably mounted to the removed end of the mast;
a communication device attached to the tilt tube at one end thereof;
a solar panel;
a standoff bracket assembly engaging the mast and the solar panel, the bracket assembly having fixed arms engaging the mast and the solar panel, and a pivot arm engaging the solar panel, the bracket assembly mounted to the mast close to the removed end so as to pivotally hold the solar panel spaced away from the mast and at a selected tilt angle with respect to the mast; and
an adjustment assembly located at or close to the near end of the mast and at the or close to the removed end, the adjustment assembly including a slideable shaft slideable with respect to the mast, for pivotally engaging the pivot arm of the bracket assembly so that movement of the slideable shaft with respect to the mast causes the pivot arm to cause the solar panel to change its tilt angle, the adjustment assembly for fixedly locating the slideable shaft when a desired solar panel tilt orientation is achieved.

8. The tilt tower of claim 7, wherein the pivot arm engages the solar panel along a top edge thereof.

9. The tilt tower of claim 8, wherein the fixed arms engage the solar panel about midway between the top edge and a bottom edge thereof to allow the panel to pivot at an engagement point.

10. The tilt tower of claim 7, wherein the fixed arms include a horizontal arm and a diagonal arm.

11. The tilt tower of claim 10, wherein the horizontal arm comprises a pair of arms and wherein the diagonal arm includes a pair of arms.
